(19) United States
(12) Patent Application Publication
(10) Pub. No.: US 2010/0007554 A1
(43) Pub. Date: Jan. 14, 2010

(54) GNSS broadcast of future navigation data for anti-jamming

(76) Inventors: Hanching Grant Wang, Hacienda Heights, CA (US); Dwayne C. Merna, Yorba Linda, CA (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/796,442

(22) Filed: Apr. 27, 2007

(51) Int. Cl. G01S 1/00

(52) U.S. Cl. 342/357.12

(57) ABSTRACT

A system and a method wherein future navigation data is broadcast on one channel and current navigation data is broadcast on another channel. By instituting minor changes in message structure, anti-jamming capability can be enhanced. In accordance with one method, future navigation data is distributed by satellites to receivers for tracking of a conventional channel. In accordance with another method, part of the future navigation data (i.e., ephemeris and clock data) is distributed by satellites to receivers for use with a dataless channel.

### TECHNICAL FIELD

The subject matter of this disclosure relates generally to the field of wireless communications and, in particular, to geographical location using wireless communications systems.

### BACKGROUND

Global Navigation Satellite Systems (GNSS) is a collective term used for satellite systems operated for navigation purposes. Currently, the following systems are known: the Global Positioning System (GPS), the in-development European Galileo, and the partial constellation of Russian GLONASS. The inventive concepts disclosed herein are directly applicable to any of the GNSS, but for the purpose of illustration, exemplary application of those concepts to the GPS will be described

The GPS has three segments: the GPS constellation of space vehicles (SVs) (i.e., satellites), a.k.a. the space segment; the networked ground ranging and control stations, a.k.a. the ground segment; and the roving GPS receivers (GPSRs), a.k.a. the user segment. The signal in space, which is the GPS signal transmitted from SVs to GPSRs, is vulnerable to potential jamming, interference, nuclear disturbance, plasma blackout and spoofing. Since jamming, interference and disturbance have some common adverse effects that can be overcome by applying the inventive concepts disclosed herein, jamming (or anti-jamming) will be discussed in what follows. Although the inventive concepts can also be used to improve the GPS navigation accuracy, later discussion will focus on anti-jamming capability. Although the inventive concepts are applicable to civilian and commercial applications, later discussion will focus on military applications.

The U.S. Department of Defense created NAVSTAR to work optimally with a constellation of 24 SVs. Each SV is equipped to transmit (i.e., broadcast) on two carriers respectively designated: L1 and L2. The L1 carrier produces a carrier phase signal at 1575.42 MHz; the L2 carrier produces a carrier phase signal of 1227.6 MHz. Binary data that is modulated or “superimposed” on the carrier signal is referred to as “code”. Two main forms of code are used with NAVSTAR GPS: C/A or Coarse/Acquisition Code (also known as the civilian code), is modulated and repeated on the L1 carrier every millisecond; the P-Code, or Precise Code, is modulated on both the L1 and L2 carrier and is repeated every seven days. The P/Y code is a special form of P code used to protect against false transmissions; special hardware, available only to the U.S. Government and allies, must be used to decrypt the P/Y code. In the future, L2 will include a C/A code signal to allow civil use of that frequency.

Modernization of the GPS will include a new waveform: M-code. M code is for military users and is designed to be more jam-resistant than P/Y code. M code is a split-spectrum signal with little energy at the carrier frequency and major lobes spaced away from the carrier. These side peaks in the modulation spectrum will be situated in the nulls of the current P/Y code signal. Any code in any of carrier from any space vehicle constitutes a signal channel.

A roving GPS receiver having a GPS SV in view is capable of downloading information about that SV's orbit and clock. An almanac is broadcast every 12.5 minutes and contains approximate orbits for the constellation, as well as atmospheric modeling. The ephemeris is transmitted every 30 seconds and contains shorter duration, more precise orbit data for a given SV.

During broadcasting, each SV produces a unique code sequence of ones and zeroes. By matching the code generated using the SV's atomic clock with that generated using the GPSR's clock, the GPSR is able to calculate a time difference. The distance between the SV and GPSR can be determined by taking the product of calculated time difference and the known speed of light. In view of clock discrepancies, the slowing of light through the atmosphere and slight inaccuracies in the broadcast almanac, this calculated distance is referred to as a “pseudo-range”. The GPSR position can be calculated by intersecting distances from multiple SVs. The respective pseudo-ranges for three satellites are required to determine a two-dimensional position; the respective pseudo-ranges for four or more SVs are necessary to determine a three-dimensional position.

Due to its inherently low signal-to-noise ratio, GPS is jamming-prone. It is not surprising that GPS jamming is a critical concern in military applications. Anti-jamming capability needs to be addressed at the overall system level involving optimal GPS receiver design, adaptive signal processing techniques, Controlled Reception Pattern Antenna (CRPA) with beamforming, steering, and nulling capabilities, SV high-power spot beam, Ultra-Tightly-Coupled (UTC) GPS/INS integration (as disclosed in U.S. patent application Ser. No. 11/286,031 filed on Nov. 23, 2005 and entitled “Ultra-Tightly Coupled GPS and Inertial Navigation System for Agile Platforms”), and signal/message structure. No single method described above can remove the jamming concern alone. In fact, the combination of all of the above methods still may not completely get rid of the jamming concern. In other words, each decibel of anti-jamming capability has its own worth.

Equation (1) below can be used to estimate the “jamming-to-signal-power ratio”, J/S, in dB, a measure of anti-jamming capability:

$$J / S = {G}_{SV} - {G}_{jammer} + 10 {log}_{10} [ Q {R}_{code} ( {10}^{- \frac{{( C / {N}_{0} )}_{threshold}}{10}} - {10}^{- \frac{{( C / {N}_{0} )}_{no \text{-} jam}}{10}} ) ] \qquad ( 1 )$$

In Eq. (1), G_{SV}, in dB, is the antenna gain toward the tracked SV; Gⱼₐₘₘₑᵣ, in dB, is the antenna gain toward the jammer; Q is the jamming resistance quality factor (e.g., 2.22 for C/A and P/Y codes, and 5.3 for M code); R_{code} is the Pseudo-Random Noise (PRN) code rate (e.g., 1.023 MHz for C/A code, 10.23 MHz for P/Y code, and 5.115 MHz for M code); (C/N₀)ₙₒ₋ⱼₐₘ, in dB, is the “carrier-power-to-noise-density ratio” if no jammer is present; and (C/N₀)_{threshold}, in dB, is the tracking threshold (the minimum “carrier-power-to-noise-density ratio” at the input to the tracking loop for maintaining tracking; tracking may be lost if the signal-to-noise ratio goes lower: low tracking threshold means high anti-jamming capability).

Equation (1) provides insight on how to improve anti-jamming capability. The employment of a CRPA antenna with beamforming, steering, and nulling increases J/S, a measure for anti-jamming, by maximizing the antenna gain toward SVs and minimizing the antenna gain toward jammers. The signal/message structure can be optimized to increase (QR_{code}). Increasing the SV signal power can increase (C/N₀)ₙₒ₋ⱼₐₘ (e.g., the M code spot beam is designed to be capable of increasing signal power by 25-30 dB). Excellent GPSR design can increase (C/N₀)ₙₒ₋ⱼₐₘ and decrease the tracking threshold (C/N₀)_{threshold}. Adaptive signal processing techniques decrease (C/N₀)_{threshold}. UTC GPS/INS integration increases J/S by reducing (C/N₀)_{threshold}.

How UTC GPS/INS integration and signal/message structure change can significantly reduce the loss-tracking threshold (C/N₀)_{threshold} (in Hz here) can be best explained by the carrier phase tracking loop Equation (2) below:

$${( C / {N}_{0} )}_{threshold} = \frac{{B}_{car}}{2 {σ}_{PLL}^{2}} ( 1 + \sqrt{1 + \frac{1 {σ}_{PLL}^{2}}{{B}_{car} {T}_{int}}} ) \qquad ( 2 )$$

In Eq. (2), B_{car} is the noise bandwidth of the carrier phase tracking loop in Hz; σ_{PLL} is the lost-tracking phase error threshold in radians [a value that is around 30 deg for a dataless GPS channel (i.e., a channel with no navigation data), and 15 deg for a channel with navigation data]; Tᵢₙₜ, in seconds, is the PRN code “predetection integration period” for use in the carrier tracking loop. Equation (2) is only applicable to the carrier phase tracking loop. Equations for frequency tracking loop, and code tracking loops for C/A code, P/Y code, and M code are slightly different, but all loops share the same physics whereby (C/N₀)_{threshold} can be reduced by reducing the loop bandwidth B_{car} or by increasing the predetection integration period Tᵢₙₜ.

A UTC GPS signal tracking loop uses an integrated navigation solution to track the incoming GPS signals, and uses the tracking error to correct the integrated navigation solution. More specifically, data from an inertial measurement unit (IMU) and all signals from multiple in-view GPS SVs are optimally combined via a Kalman filter to track the GPS signal of each code of each carrier of each space vehicle. [An IMU is a self-contained system that is used to detect altitude, location, and motion. Typically installed on aircraft or unmanned aerial vehicle, it normally uses a combination of accelerometers and angular rate sensors (i.e, gyroscopes) to track how the craft is moving and where it is.] The UTC GPS/INS includes an IMU, a GPS receiver, and a navigation processor and software. See the aforementioned U.S. patent application Ser. No. 11/286,031 for a complete description of UTC GPS/INS. UTC GPS/INS, by using, unjammable IMU data to assist carrier and code trackings, can significantly reduce the required tracking loop bandwidth B_{car}. It is well known that reducing B_{car} can reduce the loss-tracking threshold (C/N₀)_{threshold}. It is less well known that increasing Tᵢₙₜ can also reduce the loss-tracking threshold (C/N₀)_{threshold}, as indicated in the second term inside the square root in Eq. (2). It is clear that in order to realize the full benefit of UTC, one needs to simultaneously decrease B_{car} and increase Tᵢₙₜ. The total anti-jamming benefit of UTC depends on the quality of the IMU, the predetection integration period Tᵢₙₜ, and the UTC mechanization. For navigation grade IMU, the combination of UTC tracking and longer Tᵢₙₜ can achieve a 20 dB increase against jamming (e.g., using Eq. (2), reduce B_{car} from 10 Hz to 0.1 Hz and increase Tᵢₙₜ from 20 msec to 2 sec). FIG. 2 shows the loss-tracking threshold in dB-Hz for a conventional tracking loop (high bandwidth and small predetection integration period). FIG. 3 shows the loss-tracking threshold in dB-Hz for a UTC tracking loop (low bandwidth and long predetection integration period).

Predicting future navigation data requires an understanding of the components that make up GPS navigation data. Navigation data includes navigation data bits and parity bits, wherein the navigation data bits comprise a satellite identifier, timing information, satellite health indicators and orbital data, such as ephemeris and almanac information. To a minimum, the navigation data should include ephemeris of the space vehicle. FIGS. 4 and 5 depict the message structure of a complete navigation data set. Each complete navigation data set comprises 25 frames having a total of 37,500 bits, wherein each frame comprises 1500 bits and is transmitted over a 30-second interval. Thus, all 25 frames of a navigation data set are sent over a period of 12.5 minutes. Each navigation data set is valid (or does not generally change) for a fixed or non-fixed period, e.g., two hours. That is, the same basic 25 frames of a navigation data set are continuously transmitted during a data set period with a few exceptions.

Each frame includes five subframes, wherein each subframe comprises 300 bits. Subframe one includes parity bits and navigation data bits corresponding to a GPS week number, satellite accuracy and health, and satellite clock correction terms. Subframes two and three include parity bits and navigation data bits corresponding to ephemeris parameters. Most of the information transmitted over subframes one through three will not change from frame to frame during a data set period. Subframe four includes parity bits and navigation data bits corresponding to a page of almanac data, special messages, ionospheric data, timing data, page ID, satellite configuration and/or reserved data. There are a total of 25 such pages to be transmitted over the fourth subframe, wherein each page is transmitted every 25-th frame. Most of the information comprising each of the 25 pages transmitted over subframe four will not change during a data set period. Subframe five includes parity bits and navigation data bits corresponding to almanac data, satellite health, satellite ID, almanac reference time and/or almanac reference week number. There are a total of 25 such pages to be transmitted over subframe five, wherein each page is transmitted every 25-th frame. Most of the information comprising each of the 25 pages transmitted over subframe five will not change during a data set period. Each subframe includes 10 words, wherein each word comprises 30 bits. The 24 most significant bits of each word are navigation data bits, and the six least significant bits of each word are parity bits for that word.

In the current GPS signal/message structure, the navigation data is broadcast at 50 bits per second (i.e., 20-msec bit width). The navigation data includes, among others, the SV ephemeris and SV clock bias and drift needed for computing navigation solution. The navigation data becomes stale every 2 hours. In order to decode the navigation data to obtain SV ephemeris and clock bias, the PRN ranging code (e.g., 10.23 Mbits per second for P/Y code) can only be accumulated up to 20 msec (the bit width). In other words, the predetection integration period Tᵢₙₜ is limited to be less than 20 msec for decoding the navigation data. However, if the navigation data is known a priori, the predetection integration period can be increased by two orders of magnitude. The known navigation data can be used to demodulate the incoming navigation data for a GPS channel with navigation data. Similarly, if ephemeris and clock bias and drift in the navigation data are known a priori, the navigation can be performed using dataless channels (currently, the L2 channel can be configured to operate as a dataless channel). Dataless channels do not broadcast navigation data. By tracking a dataless channel, the pseudo range can be measured, together with the known ephemeris, for computing the navigation solution. In either case, the PRN ranging code can be accumulated for a much longer duration (say, seconds). This longer predetection integration period Tᵢₙₜ enables the receiver to track the PRN ranging code in much lower C/N₀ than current receivers are capable of, as per Eq. (2).

Under high vehicle dynamics, in order to be able to coherently integrate PRN code for a longer period requires using UTC GPS/INS integration. Therefore, the teachings in this disclosure and in the aforementioned U.S. patent application Ser. No. 11/286,031 complement each other in implementation to obtain a 20 dB anti-jamming capability per Eq. (2).

GPS navigation data are uploaded from the GPS control station to the SVs, unless the SVs are autonomously performing Autonav. Navigation data for 24 hours is usually known and available at the control station. The issue at hand is how to distribute this navigation data to GPS users. Various distribution methods have been proposed for distributing navigation data or SV ephemeris and clock bias and drift (two different data types), so that the PRN ranging code can be integrated beyond the 20-msec limit or a dataless channel can be used. The two data types, although differing in detail applications, are common in the means of data distribution.

One method is to distribute navigation data thru the Internet. The physical connection can be either wired or wireless via various protocols such as wi-fi, WiMAX, Bluetooth, as well as cellular phone protocol. Another method is to distribute navigation data thru the military LINK-16 tactical network or future GIG network for military users. The drawback of distributing via the Internet is that many military GPS users may have no Internet terminal or have no access to the Internet or GIG networks in the battlefield. The drawback of distributing via LINK-16 is that the distribution is limited to those vehicles/platforms with expensive LINK-16 terminals connected in the LINK-16 network. Another serious drawback of either Internet or LINK-16 distribution is that the GPS navigation data are not available when SVs are in the autonomous Autonav mode. The Autonav mode is a war-time emergency mode wherein SVs will perform on-board cross-ranging among adjacent SVs to determine their own ephemeris and clock without any upload from the control station. It is designed for certain scenarios in which the ground control stations may not be operational, and therefore, do not possess the exact ephemeris and clock bias and drift estimated on-board by Autonav.

Another related method, disclosed in U.S. patent application Ser. No. 11/615,259 filed on Dec. 22, 2006 and entitled “Satellite Navigation Without Ephemeris Update”, is to control the SV position to predetermined ephemeris so that the ephemeris can be distributed to GPS users a priori. That method requires precise orbital control with fine thrust capability of the propulsion system, and also requires the distribution infrastructure to disseminate the “controlled-to” ephemeris. However, that method does not address the SV clock error, which also needs to be estimated and distributed to the user in order to compute the navigation solution.

With M code, P/Y code, and C/A code, there are more channels broadcast than needed from each SV. Something innovative and useful can be performed using these additional channels.

### SUMMARY

This disclosure proposes a system wherein future navigation data is broadcast on one channel and current navigation data is broadcast on another channel. By instituting minor changes in message structure, anti-jamming capability can be enhanced. New methods are proposed for distributing future navigation data for tracking of a conventional channel or for distributing part of the future navigation data for use with a dataless channel. The inventive concepts disclosed herein include the following aspects.

One aspect is a global navigation satellite system comprising a first signal channel that broadcasts current navigation data; and a second signal channel that broadcasts future navigation data.

Another aspect is a method comprising the following steps performed before a future time: broadcasting current navigation data of a satellite on a first GNSS channel; and broadcasting future navigation data of the satellite on a second GNSS channel. Another aspect is a method comprising the following step performed before a future time: broadcasting future navigation data of the satellite on the spare bits in GPS navigation message subframe 4, pages 1-25 for navigation computation at a later time when the future navigation data becomes current.

A further aspect is a method comprising the following steps performed before a future time: broadcasting a signal without navigation data on a first GNSS channel from a satellite; and broadcasting future navigation data of the satellite on a second GNSS channel.

Yet another aspect is a method for reducing time-to-first-fix, comprising the following steps: broadcasting future ephemeris data on a GNSS channel; receiving the future ephemeris data; and using the future ephemeris data for acquiring a signal from a satellite.

A further aspect is a GPS receiver programmed to decode and store future navigation data received on a first channel and later use that future navigation data to demodulate and track a second channel to obtain a pseudo-range.

Another aspect is a GPS receiver programmed to decode and store future navigation data received on a first channel and later use that future navigation data to track a dataless channel to obtain a pseudo-range.

Other aspects of the invention are disclosed and claimed below.

### BRIEF DESCRIPTION OF THE DRAWINGS

FIG. 1 is a diagram depicting a GPS in accordance with the prior art.

FIG. 2 shows the loss-tracking threshold in dB-Hz for a conventional tracking loop (high bandwidth and small predetection integration period).

FIG. 3 shows the loss-tracking threshold in dB-Hz for a UTC tracking loop (low bandwidth and long predetection integration period).

FIGS. 4 and 5 are charts showing the current message structure for GPS navigation data in accordance with the prior art.

Reference will now be made to the drawings in which similar segments in different drawings bear the same reference numerals.

### DETAILED DESCRIPTION

This portion of the disclosure uses the collective term GNSS, instead of GPS, for its generality.

One embodiment disclosed herein is a method whereby a GNSS distributes navigation data for anti-jamming enhancement using the same infrastructure as the GNSS system itself, and users receive the navigation data using the GNSS receiver itself. Specifically, one channel is dedicated to broadcast the current navigation message (“current channel”), and another channel is dedicated to broadcast the future navigation data (“future channel”). All channels are part of the GNSS systems. The GNSS receivers use the same techniques to receive both current and future navigation data. The GNSS receiver will save any received future navigation message from the “future channel”. Alternatively, spare bits in navigation message subframe 4 can be used to broadcast the future navigation message data with no impact to existing GPS receivers. As time goes by, future navigation data becomes current navigation data. The GNSS receiver will then use the stored navigation data for tracking the current channel or with a dataless channel. Since the navigation data is known, the PRN ranging code can be coherently integrated for a longer period, i.e., longer than the duration of a chip in navigation data, for enhancing anti-jamming capability.

The following portions of this disclosure use the term GPS, instead of GNSS, for reader's familiarity, but the inventive concepts disclosed hereinafter are applicable to any GNSS. The description uses a military mission as an example, but the concept is applicable to other civil, commercial, and life-critical applications. The disclosed embodiment employs a method for distributing future navigation data via the GPS itself so that the distribution infrastructure already exists in the GPS (no additional infrastructure is required).

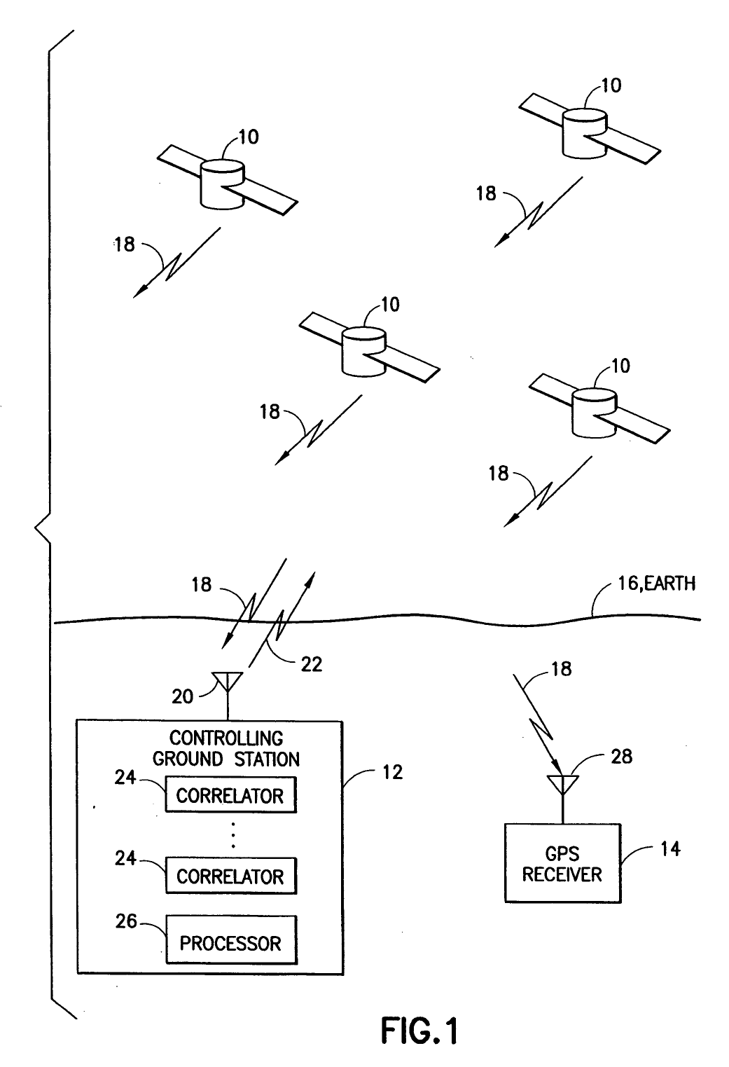

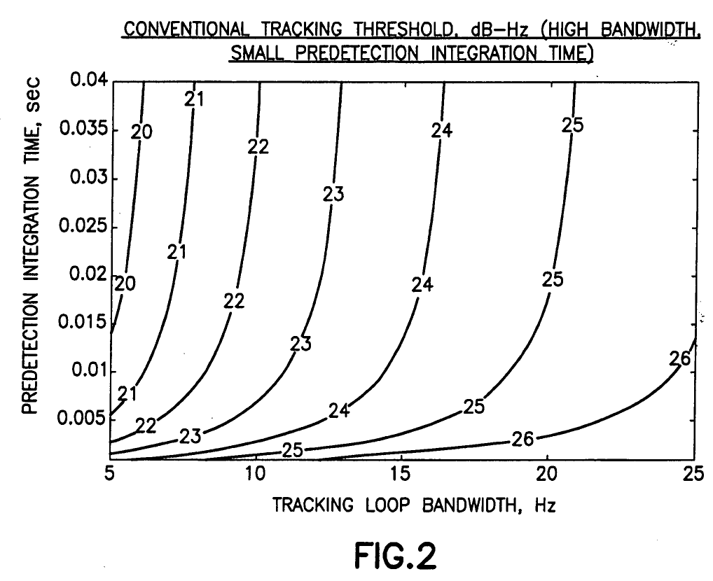

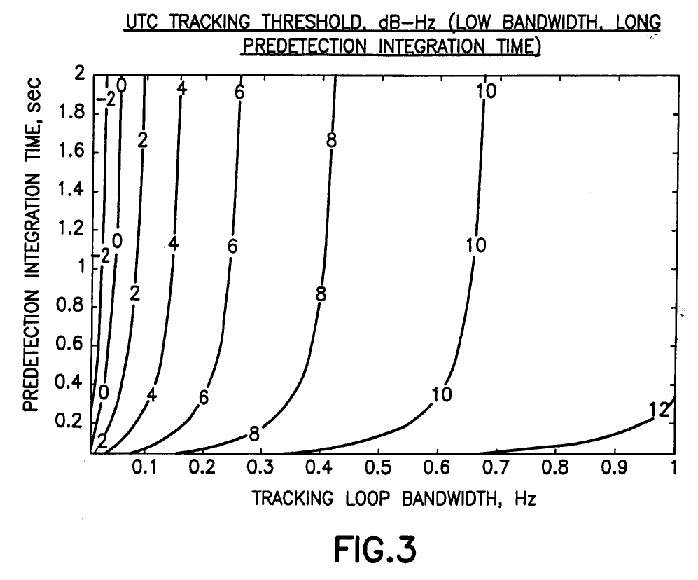

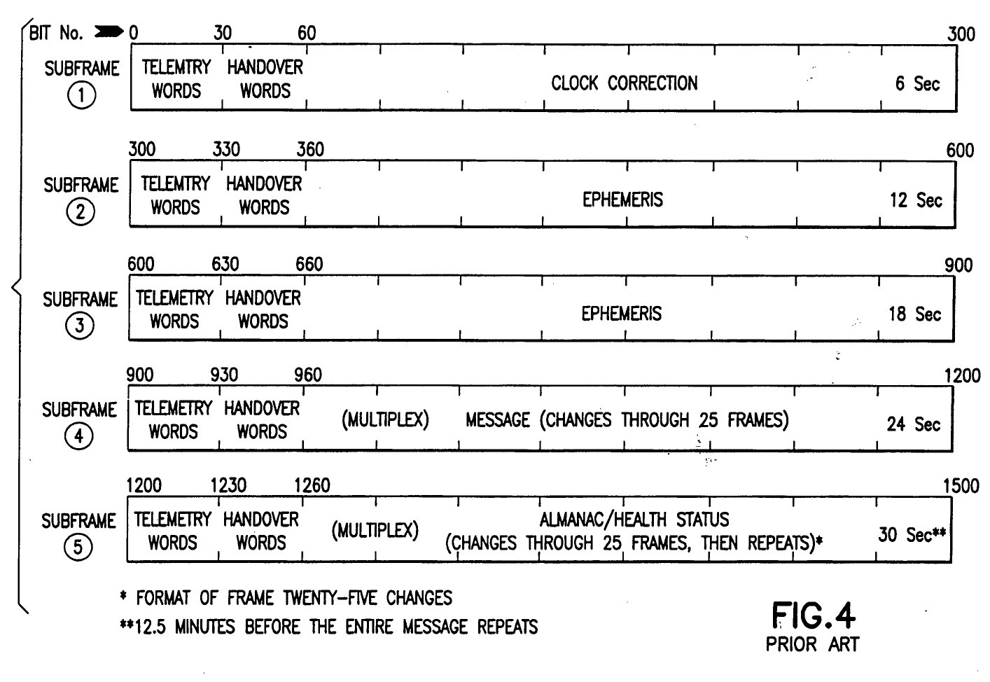

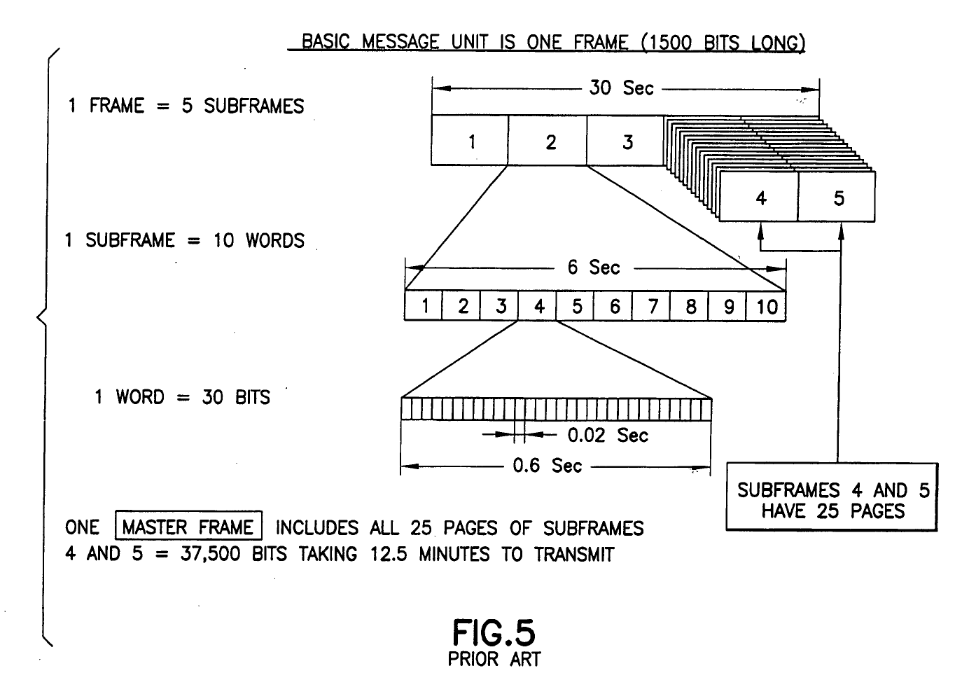

Referring to FIG. 1 the GPS comprises a plurality of satellites 10, at least one controlling ground station 12, and at least one GPS receiver 14. Each satellite orbits the Earth 16 at a known speed and is a known distance from the other satellites. GPS satellites continuously emit coded GPS signals 18. The GPS signal contains timing information that allows a user to determine the time elapsed for the GPS signal to traverse the distance between the GPS satellite and the GPS receiver. By knowing the time when the GPS signal left the GPS satellite, the time when the GPS signal arrived at the receiver, and the speed of the GPS signal, the GPS receiver can determine the distance from itself to the GPS satellite. By knowing the position of the GPS satellite (ephemeris data), and the distance from itself to the GPS satellite, the GPS receiver can successfully triangulate its own position.

The GPS signal emitted by the satellites contains L-band carrier components at the transmitted frequencies of 1.575 GHz (L1) and 1.2276 GHz (L2). The L1 carrier component is phase shift keyed (PSK) modulated by two orthogonal pseudo-random noise (PRN) codes, a precise P(Y) code at a chipping rate of 10.23 MHz and a course acquisition (C/A) PRN code at a chipping rate of 1.023 MHz. Navigation data at 50 bits per second is modulo-2 added to each ranging code. The PRN ranging codes provide timing information for determining when the GPS signal was broadcast. The data component provides information, such as, the satellite orbital position. The L2 carrier is similar to the L1 carrier except that, at the time of this writing, it contains either one but not both simultaneously PSK modulated P(Y) and C/A codes. The navigation data includes a satellite identifier, timing information, satellite health indicators, orbital data and parity bits.

Position determination using a conventional GPS receiver is well known in the art. In conventional GPS, a receiver makes ranging measurements between an antenna coupled to the receiver and each of at least four GPS satellites in view. The receiver makes these measurements from the timing information and the satellite orbital position information obtained from the PRN code and data components of each GPS signal received. By receiving four different GPS signals, the receiver can make accurate position determinations.

The controlling ground station 14 comprises an antenna 20 for receiving GPS signals 18 and transmitting correction signals 22, a plurality of correlators 24 for detecting GPS signals 18, and a processor 26 having software for tracking GPS satellites 10 using detected GPS signals 18 and for determining correction signals 22 for each satellite. Correction signals 22 include satellite clock offsets from actual GPS system time, such as bias and drift components, for purposes of providing updated position and timing information to GPS satellites 10.

The GPSR 14 comprises an antenna 28 for receiving GPS signals 18 and other components not shown in FIG. 1, such as a preamplifier/prefilter to filter and boost received GPS signals 18, a plurality of correlators for detecting GPS signals 18, a processor having software for determining a geolocation position using the detected GPS signals 18, a frequency synthesizer, and a reference oscillator to provide timing to the frequency synthesizer. A prior art GPSR incorporating such components is depicted diagrammatically in FIG. 13 of U.S. Pat. No. 6,611,756, the teachings of which patent are fully incorporated by reference herein.

Detecting GPS signals 18 involves a known correlation process wherein the GPSR correlators search received GPS signals for PRN codes in a carrier frequency dimension and a code phase dimension. Due to the Doppler effect, the frequency at which the GPS signals 18 are transmitted changes by an unknown amount before that GPS signal arrives at GPSR 14. The GPSR 14 accounts for the Doppler effect by replicating the carrier signals across a frequency spectrum until the frequency of the replicated carrier signal matches the frequency of the received GPS signal. Also, GPSR 14 replicates the unique PRN codes associated with each satellite 10 using a PRN code generator, wherein the replicated PRN codes are modulated onto replicated carrier signals via a multiplier. The phases of the replicated PRN codes are shifted across code phase spectrums until replicated carrier signals modulated with replicated PRN codes correlate, if at all, with GPS signals 18 being received by GPSR 14, wherein each code phase spectrum includes every possible phase shift for the associated PRN code.

After the GPS signals 18 have been detected by the GPSR correlators, the GPSR processor calculates pseudo-ranges for each detected satellite 10. Each pseudo-range corresponds to an estimate of the distance from the detected satellite to GPSR 14 based upon a propagation delay associated with the GPS signal 18 broadcast from the detected satellite plus delays based on timing offsets in clocks for the satellite and GPSR from actual GPS time. Three or more pseudo-range measurements are combined by the GPSR processor to determine its approximate position, as is known in the art.

With M code, P/Y code, and C/A code on L1 and L2 carriers from each SV, there are more channels than needed from each SV. This disclosure proposes to broadcast future navigation data on one channel and current navigation data on another channel. The proposed method of broadcasting future navigation data is applicable to either M code or P/Y code channels. Moreover, future navigation data could also be broadcast on a C/A code channel.

Alternatively, the spare bits in navigation message subframe 4 can be used to broadcast future ephemeris and clock data for the computation of navigation at a later time when the future ephemeris and clock data becomes current. There are 948 spare bits in subframe 4, pages 1-25. The ephemeris data requires 366 bits per SV, and the clock data requires 100 bits per SV. Ephemeris and clock data for the nearest 11 SVs requires a total of 5126 bits. This data could be broadcast in 6 times of the 12.5 minute ephemeris cycles required to broadcast all 25 pages of subframe 4 data. Methods for predicting future navigation data are well known in the art and will not be described in detail herein.

The message structure for GPS navigation data proposed herein is summarized in Table 1. The technical details are described below.

TABLE 1
Message Structure

| | First channel | Second channel |
|---|---|---|
| Channel of each SV | (current channel) | (future channel) |
| Navigation data | Current navigation | Future navigation |
| | data of tracked SV | data of 11 SVs (one |
| | | tracked SV and 10 |
| | | other adjacent SVs) |
| Data valid time duration | Up to 2 hours | Minimum of 2 hours |
| Broadcast repetition | 30 seconds (for | 3.5 minutes (for |
| cycle period | ephemeris and | ephemeris and clock |
| | clock data only) | data only) |
| | 12.5 minutes (for | 7 minutes (for |
| | complete navigation | complete navigation |
| | data) | data) |

In order to implement the disclosed embodiments, the following changes are needed: a minor change of the interface from an SV to a GPSR (Air Force document SIS-UE ICD); a minor change of ground operation and upload; a minor change of SV flight software for navigation data composition; and a minor change of GPSR software for storing and using the future navigation data (all to be detailed hereinafter). However, these changes do not affect existing GPSR that opt not to have this capability, and these changes can be implemented progressively without disrupting existing capabilities at all.

In the GPS as modified using the inventive concepts disclosed herein, navigation data is computed on the ground and then uploaded to the SVs. The SVs then broadcast the navigation data to GPSRs. Current and future navigation data are broadcast on different channels, both of which are tracked by the GPSRs. Clock and ephemeris data can be broadcast on any channel (M, P/Y, C/A), although broadcast on the M or P/Y code channels is preferred. Each GPSR can store the future navigation data and use it for decoding and tracking under a jamming environment. More specifically, in a jamming situation, a GPSR can utilize the previously received future navigation data that has turned into current navigation data at the present time to compute the navigation solution (i.e., position and velocity of the roving vehicle carrying the GPSR). The following portion of the disclosure sets forth one implementation, although many variations exist.

### Design Consideration No. 1

One design consideration is how long into the future should the navigation data be broadcast. Each navigation data set is valid for a two-hour duration; in other words, every two hours, the navigation data of each SV will change and old navigation data becomes stale. The reason that future navigation data is needed is that the current navigation data can expire any moment depending on the time of the day. The repetition cycle period of the broadcast of the future navigation data depends on how long into the future they are broadcast. For example, broadcast four hours ahead will double the time it takes to broadcast two hours ahead. Obviously, broadcasting too far into the future will make the repetition cycle period unacceptably large.

In order to choose an optimal duration into the future, one needs to examine typical military mission durations. As shown in Table 2, typical military missions in a jamming-prone battlefield are less than 2 hours. There are many other military missions that are longer than 2 hours, but they are in a benign (non-jamming) environment for a majority of the time. The duration they are in a jamming-prone hostile environment is still less than 2 hours. Therefore, broadcasting two hours ahead is sufficient to support the majority of critical military missions. In fact, broadcasting longer than two hours into the future has little additional benefit.

TABLE 2
Summary of Military Mission Duration in Jamming-Prone Battlefield

| Mission | Mission | |
|---|---|---|
| Type | Duration | Comments |
| Fighter | <2 hr | Limited by size of fuel tank. Carrying more fuel |
| Jets | | will slow the jets. In-air refuel allows jets to |
| | | carry sufficient fuel for a mission and be ready |
| | | for next one in acceptable down time. |
| Missiles | <1 hr | Most missile missions completed in minutes. |
| Guided | <1 hr | Most guide bomb missions completed in minutes. |
| Bombs | | |
| Long- | >4 hr | Although the mission is greater than 4 hr, the |
| Range | | vehicle is in a benign environment most of the |
| Bomber | | time, and has plenty of time to acquire the |
| | | future navigation data. In fact, the duration |
| | | in jamming hostile environment is typically |
| | | less than 2 hours. |

### Design Consideration No. 2

Another design consideration is how many SV's future navigation data should be broadcast from each SV. One could easily choose to broadcast future navigation data of all SVs from each SV. However, the optimal number of SV's future navigation data to be broadcast from each SV depends on how long into the future navigation data are broadcast. The longer one broadcasts into the future, the more sensible it is to include more SVs. For typical missions of 2 hours and broadcasting 2 hours into the future, to broadcast navigation data of adjacent SVs would be sufficient for covering any SV switch-over during the mission. For example, one tracked SV, two adjacent SVs on the same orbit plane, and 4 SVs each on each of the two adjacent orbit planes, making a total of 11 SVs, should be sufficient. In other words, the next 2 hours of navigation data for 11 SVs will be broadcast from each SV. Since a GPSR typically tracks multiple SVs, the total number of SVs for which the GPSR has their future navigation data will be greater than 11. This provides good coverage for switch-over during the mission.

### Design Consideration No. 3

A third design consideration is what data should be included in the broadcast future navigation data and how long will it take to broadcast that data. The GPS navigation data major frame is 1,500 bits long and transmitted at 50 bps, taking a total of 30 seconds. The major frame is subdivided into 5 subframes, each subframe is 300 bits long and takes 6 seconds to transmit. Subframe No. 1 mainly contains the SV clock data, and subframes 2 and 3 mainly contain the SV ephemeris data. Subframes 4 and 5 mainly contain the almanac of all SVs in the GPS constellation. The same data in subframes 1-3 are transmitted in every major frame, while subframes 4-5 are cycling among 25 different pages. Therefore, it will take the transmission of 25 major frames to cycle thru the complete navigation data, taking 12.5 minutes.

This disclosure proposes two message structures; each can be used in two different ways. The first message structure is to broadcast the complete navigation message. This first message structure can be used in two ways: 1) to track a dataless channel for pseudo-range (or its equivalent), and then use the navigation data and the pseudo-range in computing the navigation solution; 2) to use the navigation data to demodulate and track a channel to obtain pseudo-range (or its equivalent), and then use the navigation data and the pseudo-range in computing the navigation solution.

The second message structure is to broadcast only the ephemeris and clock data, subframes 1-3, in the navigation data set. This second message structure can be used in two ways: 1) to track a dataless channel for pseudo-range, and then use the stored ephemeris and clock data and the pseudo-range in computing the navigation solution; 2) new message structure for both current navigation data and future navigation data: Since future navigation data of 11 adjacent SVs are broadcast in each SV, there is little use of the almanac in the subframes 4 and 5 in the existing navigation data for assisting new SV signal acquisition. If other functionalities implemented in subframes 4 and 5 are not needed, then subframes 4 and 5 can be completely eliminated. As time passes, this future ephemeris and clock data (in subframes 1-3) can be used to demodulate and track the “current channel” for pseudo-range, and then use the stored ephemeris and clock data and the pseudo-range in computing the navigation solution. Broadcasting only the ephemeris and clock data can shorten the cycle period from 7 min to 3.5 min for cycling thru 11 SVs. Spare bits in subframes 1-3 can be used to indicate the corresponding SV number for each broadcast future navigation data. Table 3 compares the two message structures described above.

TABLE 3
Comparison of Two Message Structures

| | 1) Broadcast only | |
|---|---|---|
| | ephemeris and | 2) Broadcast complete |
| | clock data | navigation data |
| Data contents | Only subframes 1-3 | Subframes 1-3, 11 pages |
| | of the navigation | of subframe 4, and 25 |
| | data | pages of subframe 5 |
| Data size per SV | 3 pages per SV | 36 pages + 3 pages |
| | | per SV |
| Total data size | 33 pages | 69 pages |
| for 11 SVs | | |
| Total transmit time | 3.5 minutes | 7 minutes |
| (repeat cycle period) | | |

### Design Consideration No. 4

A further design consideration is how to implement the new message structure. The proposed implementation does not require all SVs to adopt this new message structure to be effective. Even if only some selected SVs implement this new message structure, there is still a sizable benefit in anti-jamming capability. For each SV participating in this new protocol, a channel will be assigned to transmit the future navigation data (“future channel”).

For a new SV with M code, P/Y code and C/A code on both L1 and L2 channels, the assignment of a “future channel” has more flexibility: any of the L2(P/Y) or L1(P/Y) channels can be assigned to broadcast future navigation data; L2(M) and L1(M) that can operate at high power will be used for obtaining the pseudo-range measurement. When the M code is fully deployed, it would be beneficial to keep the P/Y code operational for broadcasting future navigation data and to serve other functions. However, if P/Y code is not available, L2(C/A) can be chosen to broadcast future navigation data without affecting civil and commercial applications.

To implement the broadcasting of future navigation data, there will be a minor change in the operation of the ground segment to configure certain channels on certain SVs to participate in broadcasting future navigation data (a one time only or infrequently performed task), and to upload navigation data of adjacent SVs to each SV daily (currently, the capability exists to upload navigation data of all SVs via each SV). There will be also a minor change in the SV flight software to take the future navigation data, instead of current navigation data (currently the software always take the current navigation data), in composing the signal. All these changes are easy and minor.

### Design Consideration No. 5

Another design consideration is how will participating GPSRs receive future navigation data. For GPSRs that opt not to have this anti-jamming enhancement, this proposed enhancement to the remainder of the system will not disrupt the operation of non-participating GPSRs and no GPSR change is required. For GPSRs that implement this anti-jamming enhancement, the GNSS signal/message structure has to be known to the GPSR users. Accordingly, a minor software modification is needed to store the future navigation data of multiple SVs, and use them in a hostile jamming environment for demodulation and navigation in one of the two ways described in Design Consideration No. 4.

One may wonder how a GPSR can possess the future navigation data in a jamming environment. The key is to understand that in a jamming environment, the PRN code should be coherently integrated longer than the chip width of navigation data bit in order to track the PRN code at such lower signal-to-noise-density ratio. Therefore the navigation data has to be known and stored already before entering the jamming environment. This poses little constraint as a typical military mission starts in a benign environment (friendly territory) and then gradually enters the hostile environment (adversary target region in adversary territory), A GPSR will be given enough time to acquire and store the future navigation data. In fact, after the first GPS signal is acquired, it only takes 3.5-7 minutes to store future navigation data of all 11 SVs. In other words, 3.5-7 minutes in an unjamming environment is sufficient time to store all the future navigation data to be used in a jamming environment.

One benefit of using the invention concepts disclosed herein, together with the teaching of U.S. patent application Ser. No. 11/286,031, is a 20-dB increase in anti-jamming capability. Another benefit is improved accuracy by noise reduction (by integrating for a longer period). A further benefit is faster time-to-first-fix of new SV acquisition (in future time) by using precise ephemeris in future navigation data versus almanac data in current navigation data. In other words, a GPSR does not need to wait 30 seconds to acquire the next current ephemeris data because the GPSR already has the future ephemeris data.

The major advantages of this invention over other methods are: 1) the distribution infrastructure is the same as the GPS system itself so that there is no need to build or rely on additional distribution infrastructure; 2) the receiving device is the same as the GPS receiver itself so that there is no need for any additional receiving terminal or protocol; 3) as long as the environment allows a user to receive the current GNSS signal on the “current channel”, the user will have the same chance to receive future navigation data on the “future channel”, and have the benefit of anti-jamming enhancement. The GPSR of a vehicle/platform is typically moving from a benign environment into the hostile environment for typically military missions. Storing future navigation data can be performed while the GPSR is in a benign environment.

Application of the inventive concepts disclosed herein will improve the anti-jamming capability for military users, and life-critical application users.

While the invention has been described with reference to certain embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. A global navigation satellite system comprising a first signal channel that broadcasts current navigation data; and a second signal channel that broadcasts future navigation data.

2. The system as recited in claim 1, further comprising a receiver programmed to receive and store said current and future navigation data, use said current navigation data during a first time period to determine a first navigation solution, and later use said future navigation data during a second time period subsequent to said first time period to determine a second navigation solution.

3. The system as recited in claim 2, wherein said future navigation data comprises a complete navigation data set.

4. The system as recited in claim 3, wherein said receiver is programmed to track a dataless channel to obtain a pseudo-range and then use said future navigation data and said pseudo-range in computing a navigation solution representing a position of said receiver.

5. The system as recited in claim 3, wherein said receiver is programmed to use said future navigation data to demodulate and track said first channel to obtain a pseudo-range and then use said future navigation data and said pseudo-range in computing a navigation solution representing a position of said receiver.

6. The system as recited in claim 2, wherein said future navigation data consists of the ephemeris and clock data, GPS message subframes 1-3, of a navigation data set.

7. The system as recited in claim 6, wherein said receiver is programmed to track a dataless channel to obtain a pseudo-range and then use said ephemeris and clock data and said pseudo-range in computing a navigation solution representing a position of said receiver.

8. The system as recited in claim 6, wherein said receiver is programmed to use said future navigation data to demodulate and track a channel to obtain a pseudo-range and then use said ephemeris and clock data and said pseudo-range in computing a navigation solution representing a position of said receiver.

9. The system as recited in claim 1, wherein said future navigation data includes ephemeris data for multiple satellites.

10. A method comprising the following steps performed before a future time:
broadcasting current navigation data of a satellite on a first GNSS channel; and
broadcasting future navigation data of said satellite on a second GNSS channel.

11. The method as recited in claim 10, further comprising the following steps performed by a receiver:
receiving said future navigation data from said second GNSS channel; and
using said future navigation data to track signal on said first GNSS channel at said future time.

12. The method as recited in claim 11, further comprising the following steps performed by said receiver:
using said future navigation data to demodulate and track said first GNSS channel to obtain a pseudo-range; and
using said future navigation data and said pseudo-range to compute a position of said receiver at said future time.

13. A method comprising the following steps performed before a future time:
broadcasting a signal without navigation data on a first GNSS channel from a satellite; and
broadcasting future navigation data of said satellite on a second GNSS channel.

14. The method as recited in claim 13, further comprising the following steps performed by a receiver:
receiving said future navigation data from said second GNSS channel;
tracking said signal on said first GNSS channel at said future time to obtain a pseudo-range representing an approximate distance between said satellite and said receiver; and
using said future navigation data and said pseudo-range to compute a position of said receiver at said future time.

15. The method as recited in claim 13, wherein said future navigation data includes ephemeris data for said satellite.

16. A method for reducing time-to-first-fix, comprising the following steps:
broadcasting future ephemeris data on a GNSS channel;
receiving said future ephemeris data; and
using said future ephemeris data for acquiring a signal from a satellite.

17. A method comprising the following steps:
broadcasting future ephemeris data on a GNSS channel;
receiving said future ephemeris data; and
using said future ephemeris data for computing position at a later time.

18. The method as recited in claim 17, wherein said broadcasting future ephemeris data on a GNSS channel includes broadcasting future ephemeris data using spare bits in the GNSS message on a GNSS channel.

19. A GPS receiver programmed to decode and store future navigation data received on a first channel and later use that future navigation data to demodulate and track a second channel to obtain a pseudo-range.

20. The GPS receiver as recited in claim 19, wherein said first and second channels are M code channels.

21. The GPS receiver as recited in claim 19, wherein said first and second channels are P/Y code channels.

22. A GPS receiver programmed to decode and store future navigation data received on a first channel and later use that future navigation data to track a dataless channel to obtain a pseudo-range.
